(19) United States
(12) Patent Application Publication
(10) Pub. No.: US 2015/0014087 A1
(43) Pub. Date: Jan. 15, 2015

(54) Television Sound Deflector

(71) Applicant: Stanley Gail Coates, Proctorville, OH (US)

(72) Inventor: Stanley Gail Coates, Proctorville, OH (US)

(21) Appl. No.: 13/846,313

(22) Filed: Jul. 10, 2013

(51) Int. Cl. G10K 11/28

(52) U.S. Cl. CPC G10K 11/28
USPC 181/175

(57) ABSTRACT

The present invention provides a device which is structured to direct the sound from the bottom of flat screen television sets to the listening audience. The device(s) is comprised of semi rigid black plastic resin and is of fire retardant grade. Adhesive tape is included for securing the article to the television. A two inch square block is included for use in case the television has an indention indention

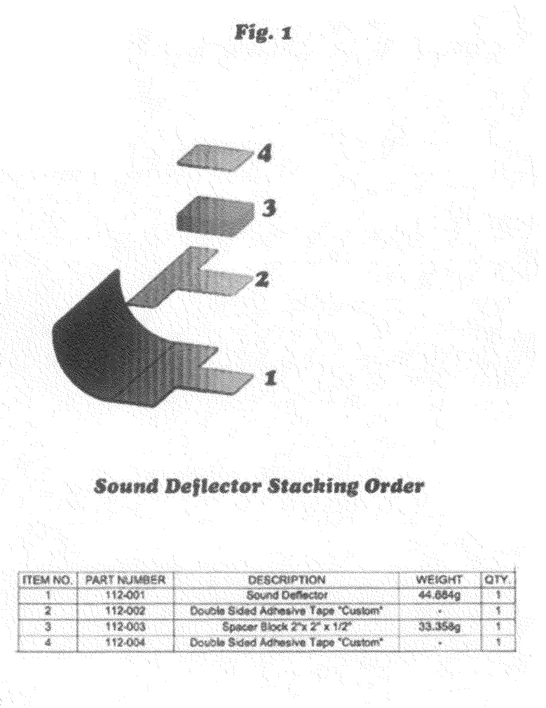

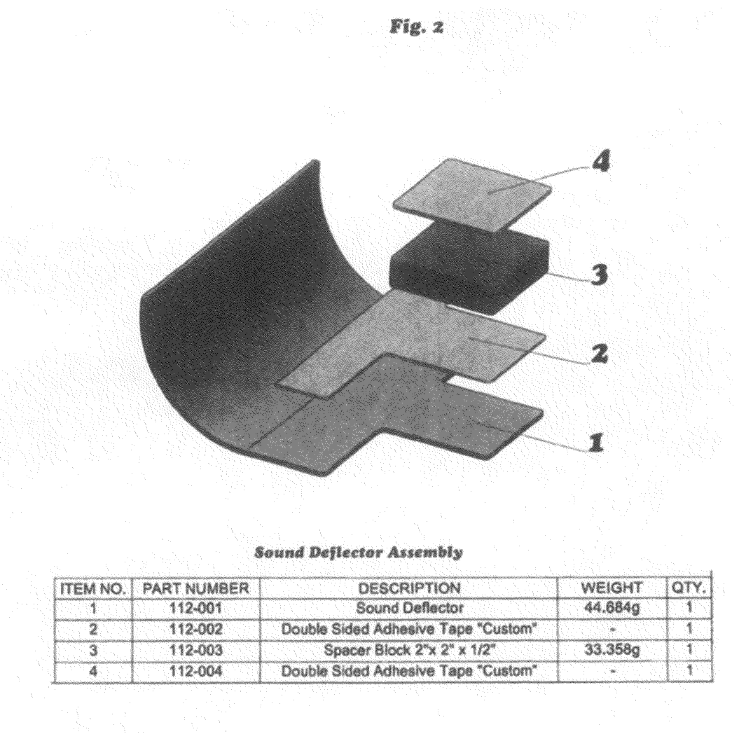

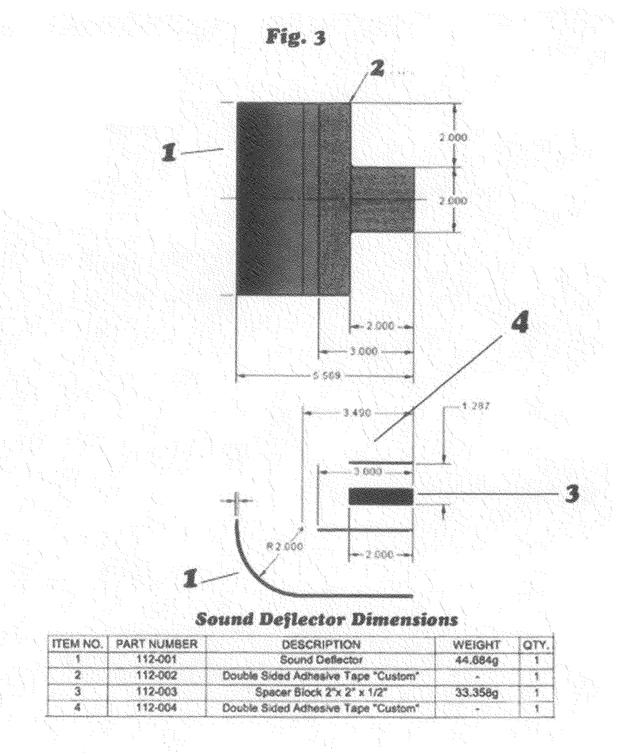

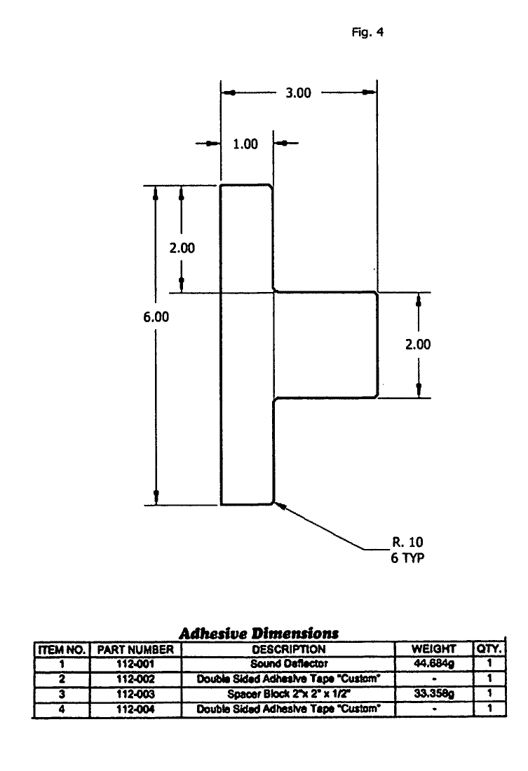

Television Sound Deflector is a devise that directs the sound from the television to the listening audience. It consists of two deflectors both which will have two-sided tape attached. The tape is to be Removed from one deflector and applied to the back of the television with the “J” curve directly under The television speaker and toward the front of the set. The second deflector is to be applied to the Remaining speaker in the same manner.

I Stanley G. Coates, a resident of Proctorville, Ohio and a citizen of the United States, do declare that I am the original and first inventor of the “Television Sound Deflector”. After nearly two years in development, Television Sound Deflector is ready to be introduced to assist people with minor hearing deficiencies.

### DESCRIPTION OF DRAWINGS OF PAGES 4 THRU 7

Pages 5 and 6 shows the article in different views.

Page 7 shows the article and its dimensions.

Page 8 shows the adhesive tape and its dimensions.
Part # 1 Shows the Sound Deflector.
Part # 2 Shows the two-sided tape.
Part # 3 Shows the 2″×2″×½″ block.
Part # 4 Shows the 2″×″ the two-sided tape.
Refer to item box regarding items 1 thru 4

### BACKGROUND OF THE INVENTION

For several years flat screen televisions have been known to provide inadequate sound to the listening audience. Manufactures of flat screen televisions have chosen to sacrifice sound quality in favor of a clear television surface. This in turn distorts the sound quality, especially to those with minor hearing deficiencies. Poor sound quality has been documented in many television reviews. At the present time the only way to correct this problem would be to purchase a sound system which is quite expensive. Many seniors have minor hearing problems but cannot afford to purchase an expensive sound system. After nearly two years of evaluation “Television Sound Deflector” was developed, to assist those with minor hearing deficiencies to enjoy television broadcast without spending and excessive amount of money. “Television Sound Deflector” is easy to apply, in that it is attached to the back of the television with two-sided tape, covering the speakers which in turn direct the sound to the listening audience.

### Description Of Invention Television Sound Deflector

“Television Sound Deflector” is a new product in that it directs the sound from the bottom of Flat Screen Televisions toward the listening audience without the requirement of batteries or electricity. This is achieved by using an injection molding process to form a semi rigid plastic resin into a shape of a “J”. Two-sided tape will be applied to each article. It will be necessary to remove the plastic protective covering before attaching the deflector to the back of television directly over the current speakers. There will be Two “j” forms and one spacer block as some televisions sets have an indention which will require this part. All plastic parts have a semi flat surface which will blend in with the decor of the television screen.

### SUMMARY

Nearly all manufactures of flat screen televisions have positioned the speakers to omit sound to the floor or back of a cabinet on which the television is setting. Turning up the volume distorts the sound and will annoy others present. Many people have hearing deficiency of varying degrees which makes television less enjoyable. This new article will direct the sound to the listening audience for better enjoyment. It is easy to use as it contains no wiring or batteries and is attached to the television by the use of two-sided tape. The “J” shape of the article directs the sound to the listening audience.

The embodiments of the invention in which an exclusive property or privilege is claimed are defined as follows:

1. This semi rigid black plastic sound directional device is comprised of two “J” shaped forms and one spacer block. Two sided tape is used for attaching the device to the back of the television.

2. A device as in claim 1, wherein said device comprises a “J” shape radius of R2.00 cm and a thickness of 0.079 cm.

3. A devise as in claim 1. Wherein said directional device consist of an overall length of 7 inches and a width of 5 inches to 13 inches.

4. A device as in claim 1, wherein said spacer block consists of 2″×2″×½.
